(19) United States
(12) Patent Application Publication
(10) Pub. No.: US 2009/0283587 A1
(43) Pub. Date: Nov. 19, 2009

(54) CHARITABLE GIFT GIVING SYSTEM AND METHOD

(76) Inventor: Anthony DiBello, Rensselaer, NY (US)

Correspondence Address: SCHMEISER, OLSEN & WATTS, 22 CENTURY HILL DRIVE, SUITE 302, LATHAM, NY, 12110, US

(21) Appl. No.: 12/466,492

(22) Filed: May 15, 2009

Related U.S. Application Data
(60) Provisional application No. 61/053,444, filed on May 15, 2008.

(51) Int. Cl. G06K 5/00; G06F 17/00

(52) U.S. Cl. 235/380

(57) ABSTRACT

Disclosed herein is a system for facilitating charitable gift giving including a card request interface configured to provide a charitable gift card to a requestor. The charitable gift card is tagged with identification information. The computerized system further includes a server comprising a payment interface configured to accept a payment and credit a value of money corresponding to the payment to the charitable gift card, wherein the payment interface is separate from the card interface, and a charity selection interface. The charity selection interface is configured to accept information related to the identification information, receive a selection of a donee charity and an amount to be paid using the identification information, pay the donee charity the amount to be paid, and deduct the amount to be paid from the amount credited to the charitable gift card. The system further includes a card storage database in operable communication with the server, the card storage database containing data related to the identification information, and an organization storage database in operable communication with the server, the organization storage database containing a list of selectable charitable organizations, the storage database accessible at least in part by a gift recipient.

### RELATED APPLICATION

This non-provisional application claims priority to a U.S. Provisional Application Ser. No. 61/053,444 filed May 15, 2008 with the United States Patent and Trademark Office.

### FIELD OF THE INVENTION

This invention relates generally to the field of charitable giving, and more particularly to a method and system for a gift giver to enable a gift recipient to donate to a donee charity.

### BACKGROUND

Charity is the act of giving money, goods or time to the unfortunate. The poor, particularly widows and orphans, and the sick and disabled, are most often considered the proper objects of charity. Many organizations have been formed to promote charity and may have specific causes such as food, water, clothing, and shelter to disaster victims, healing the sick, visiting the imprisoned, visiting the homebound, supporting abused or battered women and children, ransoming captives, educating orphans and advocating human rights. The saying “charity begins at home” means supporting one's family and friends. However, “charity begins at home” can also mean teaching or providing opportunities for friends and family to participate in charitable gift giving. Teaching and conveying the spirit of charity to others assists in spreading charity and goodwill throughout the world. In most religious and spiritual pursuits, charity is a much sought after virtue. For example, in Christianity, charity is an act that demonstrates the love of God and fellow man . . . for God loves a cheerful giver. II Corinthians 9:7.

Accordingly, a new method and system for teaching and conveying charitable donations would be well received in the art.

### SUMMARY OF THE INVENTION

According to one aspect of the invention, a system for facilitating charitable gift giving comprises a card interface configured to provide a charitable gift card to an individual, the charitable gift card tagged with identification information, a server comprising a payment interface configured to accept a payment and credit a value of money corresponding to the payment to the charitable gift card, wherein the payment interface is separate from the card interface, and a charity selection interface configured to accept information related to the identification information, receive a selection of a donee charity and an amount to be paid using the identification information, pay the donee charity the amount to be paid, and deduct the amount to be paid from the amount credited to the charitable gift card. The computerized system further comprises a card storage database in operable communication with the server, the card storage database containing data related to the identification information, and an organization storage database in operable communication with the server, the organization storage database containing a list of selectable charitable organizations, the storage database accessible at least in part by a gift recipient.

According to another aspect of the invention, a method of charitable gift giving comprises obtaining a charitable gift card from a card request interface, receiving the charitable gift card from the card interface, the charitable gift card tagged with identification information, accessing a server and paying money to a host of the server, the host crediting a value of money to the charitable gift card corresponding to the paid money to the host, wherein the server and the card interface are at separate locations, and giving the charitable gift card to a gift card recipient, wherein the server and the gift card are configured to allow a plurality of payments to be credited to the card.

According to yet another aspect of the invention, a method of facilitating charitable gift giving comprises establishing a plurality of card interfaces configured to accept a provide a charitable gift card to a gift giver, tagging the charitable gift card with identification information, establishing a web site comprising a payment interface and a charity selection interface, accepting, by the payment interface, a payment by the gift giver, crediting, by the payment interface, a value of money corresponding to the payment to the charitable gift card, receiving, by the charity selection interface, a selection from a gift receiver of a donee charity and an amount to be paid, paying the donee charity the amount to be paid, and deducting the amount to be paid from the amount credited to the charitable gift card by the payment interface.

### BRIEF DESCRIPTION OF THE DRAWING

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a flowchart of a method and system for a gift giver to enable a gift recipient to donate to a donee charity according to one embodiment of the present invention;

FIG. 2 discloses a front view of a Card according to one embodiment of the present invention;

FIG. 3 discloses a back view of a Card according to one embodiment of the present invention;

FIG. 4 depicts a flowchart for a method and system of using a Closed System Card for a gift giver to enable a gift recipient to donate to a donee charity according to one embodiment of the present invention;

FIG. 5 depicts a flowchart for a method and system of using a Semi-Closed System Card for a gift giver to enable a gift recipient to donate to a donee charity according to one embodiment of the present invention;

FIG. 6 depicts a flowchart for a method and system of using a Pre-paid Card Advance for a gift giver to enable a gift recipient to donate to a donee charity according to one embodiment of the present invention;

FIG. 7 depicts a flowchart for a method and system of using an IGC Card for a gift giver to enable a gift recipient to donate to a donee charity according to one embodiment of the present invention;

FIG. 8 depicts a flowchart for a method and system of a Primary Interface used for a gift giver to enable a gift recipient to donate to a donee charity according to one embodiment of the present invention;

FIG. 9 discloses a flowchart with uses for a Web Site to carry out a method and system for a gift giver to enable a gift recipient to donate to a donee charity according to one embodiment of the present invention;

FIG. 10 discloses a flowchart for Gift Software according to one embodiment of the present invention.

FIG. 11 discloses a flowchart for a payment process according to one embodiment of the present invention;

FIG. 12 discloses a perspective view of a Point of Sale according to one embodiment of the present invention;

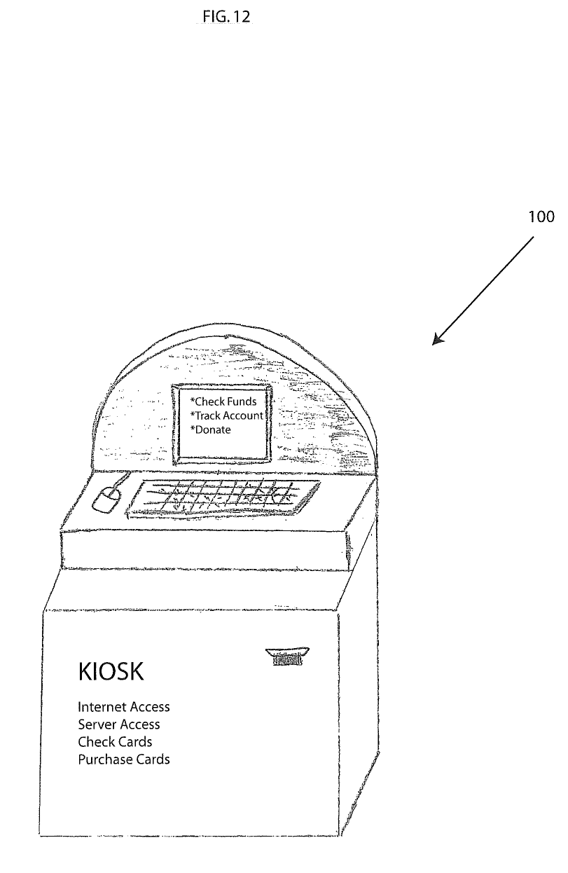

### DESCRIPTION OF THE INVENTION

A detailed description of the hereinafter described embodiments of the disclosed apparatus and method are presented herein by way of exemplification and not limitation with reference to the Figures.

As used herein: (1) “Host” shall mean the system, company or individual, or combination thereof, which hosts and sponsors the charitable gift giving operations. (2) “Gift giver” shall mean the person, company or organization, or combination thereof, which donates money or gift-in-kind and selects a gift recipient, who is able to designate a donee charity for receipt of the charitable gift funds. (3) “Gift recipient” shall mean the person, company or organization, or combination thereof, which receives the charity gift from the Gift giver, and who is able to designate a donee charity for receipt of the charitable gift funds. (4) “Donee charity” shall mean the company or organization, or combinations thereof, which finally receives the charitable gift funds. A donee charity will typically be a registered non-profit organization that enjoys a tax-exempt status.

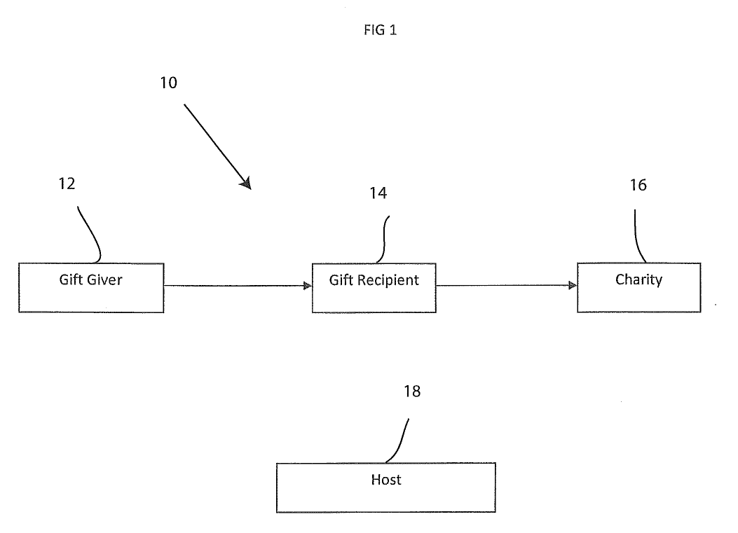

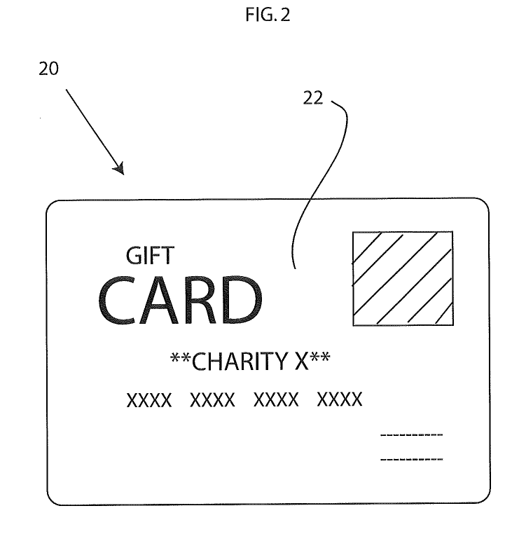

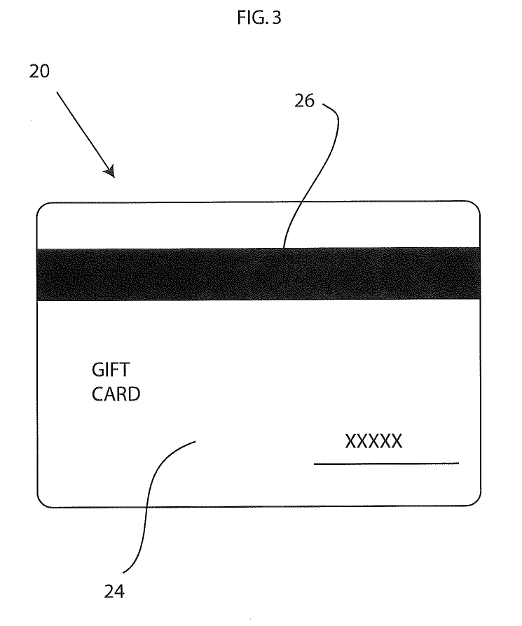

Referring first to FIG. 1, a method for charitable gift giving 10 of the present invention provides a host 18. The host 18 may comprise a mechanism and infrastructure for a third party or a gift recipient 14 to designate a charity 16 which will benefit from a transaction between a gift giver 12 and the gift recipient 14 that designates the charity 16. Shown in FIGS. 2 and 3, the present invention uses a physical or electronic stored-value card 20 which represents money on deposit with the card host 18. The stored value card 20 differs from a debit card in that a debit card is usually issued in the name of individual account holders, while the stored-value card 20 may be anonymous. The card 20 may be tagged with identification information. Thus, the stored value on the card 20 may be zero, or more, depending on how much a gift giver 12 pays. If the gift giver 12 simply requests the card 20, and does not put money on the card 20, the value stored will remain at zero.

Referring still to FIGS. 2-3, the stored-value card 20 maintains the actual value on computers affiliated with the card issuer. The stored-value card 20 may include a front face 22 and a back face 24. The value associated with the card 20 can be accessed using a magnetic stripe 26 embedded in the back face 24 of the card 20, on which the card number is encoded; using radio-frequency identification (RFID); bar coding; or by entering a code number, printed on the card, into a telephone, computer database, such as on a website or other numeric keypad. The stored-value card design could incorporate themes such as animal lover themes, children themes, holiday themes, etc. The card design could also incorporate causes or special interests, political, humanitarian, religious, for example environmental interests, animal rights, disaster relief, etc.

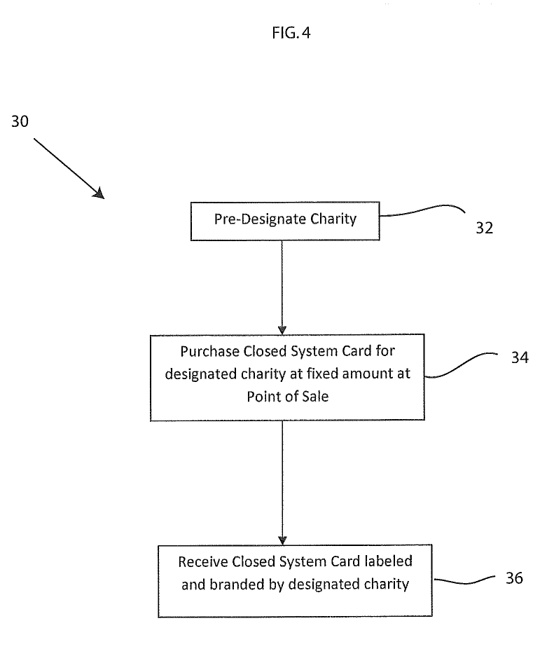

Shown in FIG. 4, a closed system card method 30 is shown according to the present invention. In this method, the gift giver 12 or other purchaser may pre-designate a charity 32. Next the gift giver 12 may purchase a closed system card for the designated charity at a fixed amount at a point of sale 34. The point of sale may be a vending machine or a Kiosk 100 (shown in FIG. 1), or Point of Sale purchase site such as health and fitness center, bank, a corporation, post office, retail outlet, floral store, hospital, church, school, shopping mall can sell a closed system card for a charitable organization such as a church, school, hospital, research organization, disaster relief organization, etc, wherein the purchaser would have a charity pre-designated for the recipient. Purchasers buy a card 20 for a fixed amount and can only use the card at the charity that issues the card. The method my finally comprise the purchaser receiving the closed system card 36. In this case the card 20 can be private labeled and branded by the designated charitable organization. Alternatively, a card may be picked up, received, given, or obtained by a gift giver 12 at a church, school, shopping mall or other site where it is in a display or other presentation. Further, the card may be received or obtained in the mail.

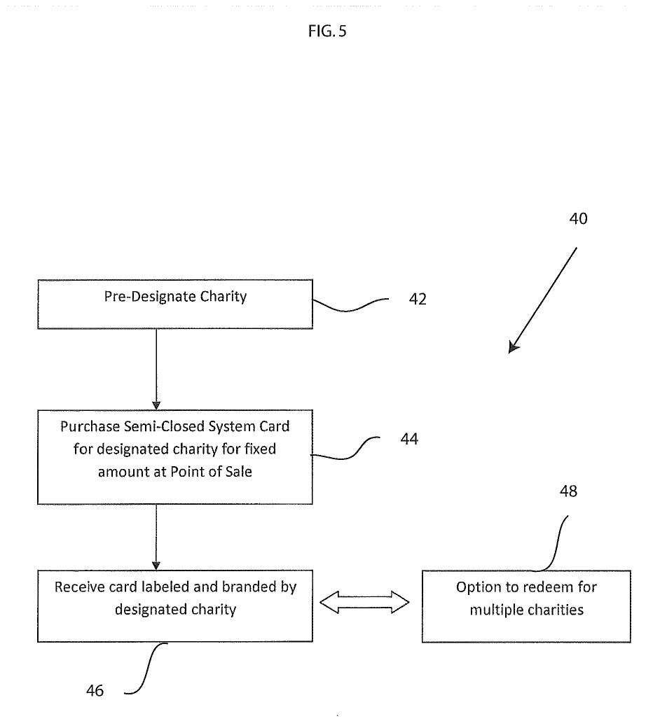

Referring now to FIG. 5, a semi-closed card method 40 is shown. In this embodiment, similar to the method 30, the gift giver 12 or other purchaser may first pre-designate a charity or group of charities 42. The purchaser or gift giver 12 would then purchase the semi-closed system card for the designated charity or group of charities for a fixed amount at a point of sale 44. “Semi-closed system cards” are similar to closed system cards. However, cardholders or gift recipients 14 are permitted to redeem the cards 20 at multiple of the charities 16. Examples of multiple charities may include groups of charities such as a group of universities or churches in a geographic region. The charity 16 or group of the charities 16 may need to first register with the host 18. The gift giver 12 may then give the card to the gift recipient 14. The gift recipient may then receive the card 20 which may be labeled and branded by the designated charity or the group of charities 46. The gift recipient 14 may then designate the particular donee charity 16, while having an option to redeem the card 20 for multiple charities 48.

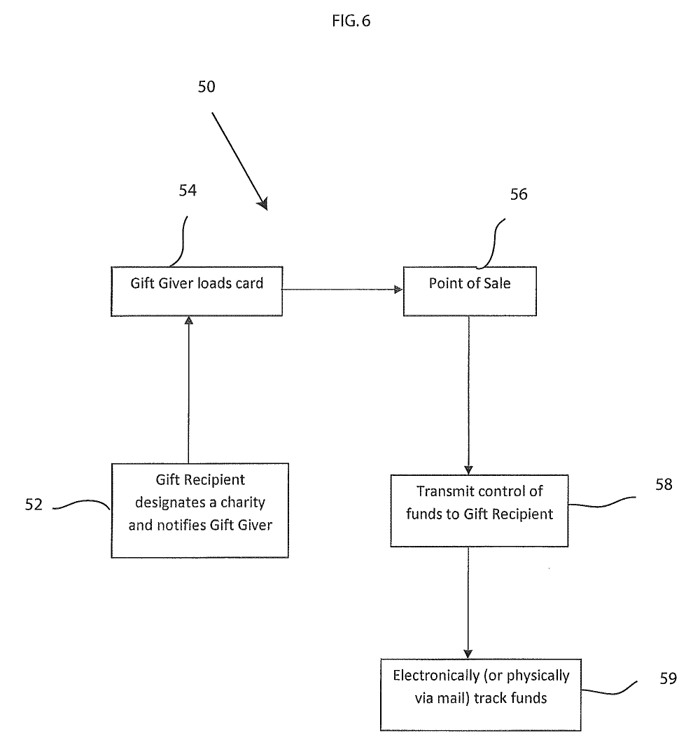

Referring now to FIG. 6, a method using pre-paid card advances 50 is shown according to another embodiment of the present invention. The method 50 permits the gift giver 12 to track in real time the results of the gift they have provided to the gift recipient 14 and which charity 16 is designated. The gift giver 12 may process the transaction through the POS or kiosk 100, a website, mobile phone, personal display apparatus (PDA), television via the internet, etc. and physically and/or electronically transmit the gift. In this invention, the gift recipient 14 may optionally first designate a charity or charities and notify the gift giver 52. The gift giver 12 may then load the card 54 at the point of sale 56. The gift giver 12 may then transmit control of the funds to a gift recipient with the funds earmarked for a charitable organization 58. The gift giver 12 may then view or track how the funds as they are being utilized in real time 59. The tracking in step 59 of the method 50 may optionally be automatically notifying the gift giver 12 via mail, text-messaging or other electronic means when the funds have been donated. It should be understood that the gift giver 12 may also be notified via a mobile phone.

It should be understood that the present invention contemplates a computerized system for facilitating charitable gift giving. The computerized system may include a web site or server, and an accompanying database or databases in communication with the web site 72 or server 76. The system may include a card interface configured to accept a request for a charitable gift card 20 and provide the charitable gift card 20 to a requestor such as the gift giver 12. The card interface may be the kiosk 100, or a web site as described herein. Alternately, the card interface may simply be a display at a store, bank, church or other location. Furthermore, the system may include a payment interface configured to accept payment and credit a value of money corresponding to the payment to the charitable gift card 20. The system may also include a charity selection interface configured to accept information related to the identification information or data on the card 20. The charity selection interface may also receive a selection of a donee charity 16 and an amount to be paid using the identification information. Finally, the charity selection interface may be configured to pay the donee charity 16 the amount to be paid and deduct the amount to be paid from the amount credited to the charitable gift card 20. It should be understood that the payment interface and the charity selection interface may be part of the server 76 or the web site 72. Furthermore, the payment interface and the card request interface may be completely separate interfaces. This allows a user to obtain a card from the kiosk 100, for example, and use later transfer more money onto the card. Furthermore, the card may be used by multiple users. For example, the card 20, having an identification number, may be purchased from the host 18 at a web site 72 by a gift giver 12. The gift giver 12 may then put transfer money onto the card 20. The gift giver 12 may then give the card to a gift recipient 14 who donates that money to a selected charity. The gift recipient may then use the identification information associated with the card 20 to transfer further funds to the card 20 and then give the card 20 to a second gift recipient.

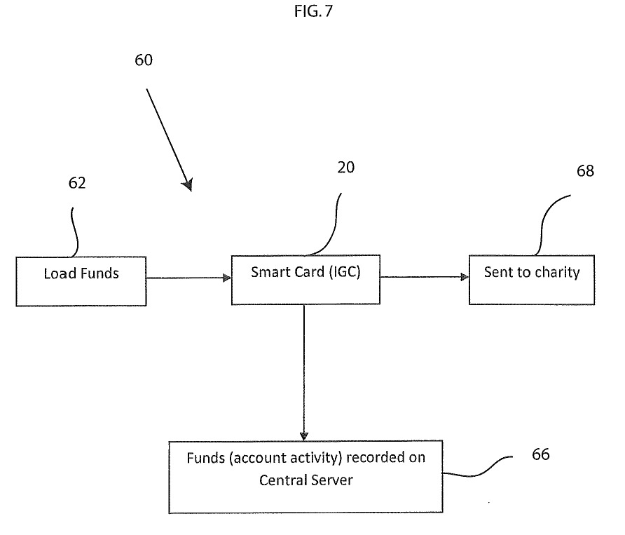

A fourth embodiment of the present invention is shown in FIG. 7. Depicted is a method 60 utilizing a smart card, such as the card 20 (as depicted in FIGS. 2-3). The smart card, chip card, or integrated circuit card (ICC) 20 according to the present invention is any pocket-sized card with embedded integrated circuits which can process information. Funds may be loaded 62 onto a smart card 20 which may be recorded on a website or central server 66. The card 20 may then be sent to charity 68 by being physically mailed to a charitable organization that would have a code provided to unlock the funds. The card 20 may be made of plastic, generally PVC, but sometimes ABS. The card 20 may embed a hologram 22 (shown in FIG. 2) to avoid counterfeiting.

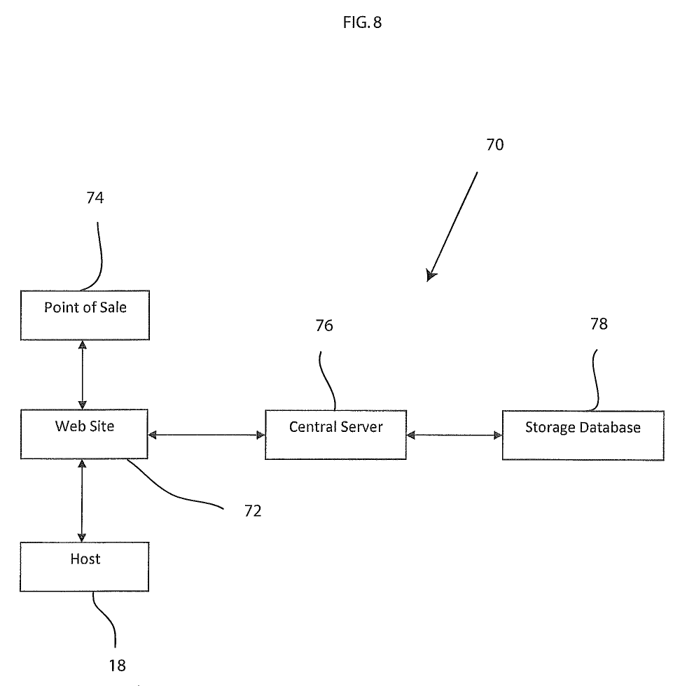

Shown in FIG. 8 is a primary interface 70 according to the present invention. In all embodiments, a web site 72 is the primary interface between the host 18 and the point of purchase 74. The web site 72 resides on central server 76, which is in communication with a storage device or database 78 for storing charity gift information. The database may also be for storing information regarding designated charitable organizations. The database may include a plurality of databases. For example, the database may include a card storage database in operable communication with the server 76. The card storage database may contain data related to the identification information of the card 20. Furthermore, the database may include an organization storage database in operable communication with the server. The organization storage database may contain a list of selectable charitable organizations, and may be accessible by the gift recipient 14 when choosing which organization to donate to.

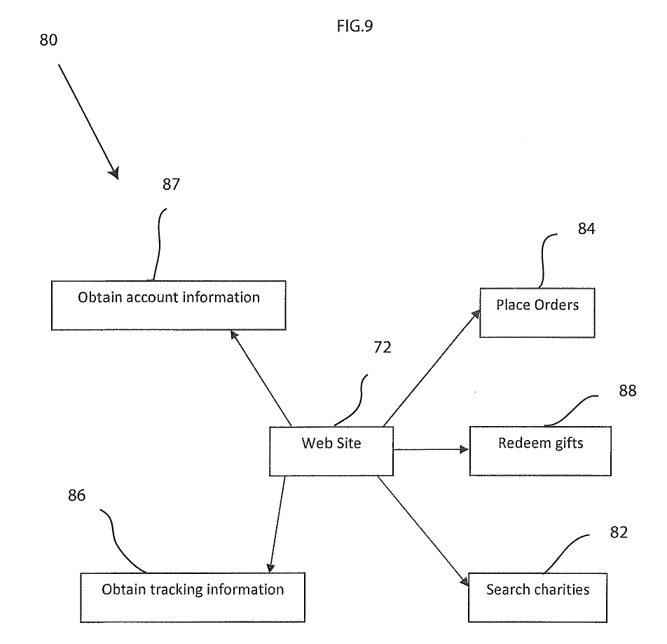

FIG. 9 depicts a flowchart 80 with uses for the web site 72 to carry out a method and system for a gift giver 12 to enable a gift recipient 14 to donate to a donee charity 16 according to one embodiment of the present invention. The web site 72 allows the gift giver 12 and other customers to search for and learn about the charities 82, place orders 84, register the card, obtain tracking information 86 and account donation information 87 and redeem gifts 88. The public web site also serves as the mechanism for charities 16 to update their information in charitable organization database, track charitable gift information, and serve as a payment processing mechanism for donations made to their organization. Visitors may also search the charitable organization database and view detailed information about the charities 16 which have created accounts with host. Gift givers 12 may track gifts that they have given to obtain the results of their gift. In addition, contact information, a list of the “top givers,” general information and frequently asked questions could be available to the public on the website to encourage charitable gift giving. The public website could also display any affiliate programs, charitable partners, and corporate partners involved.

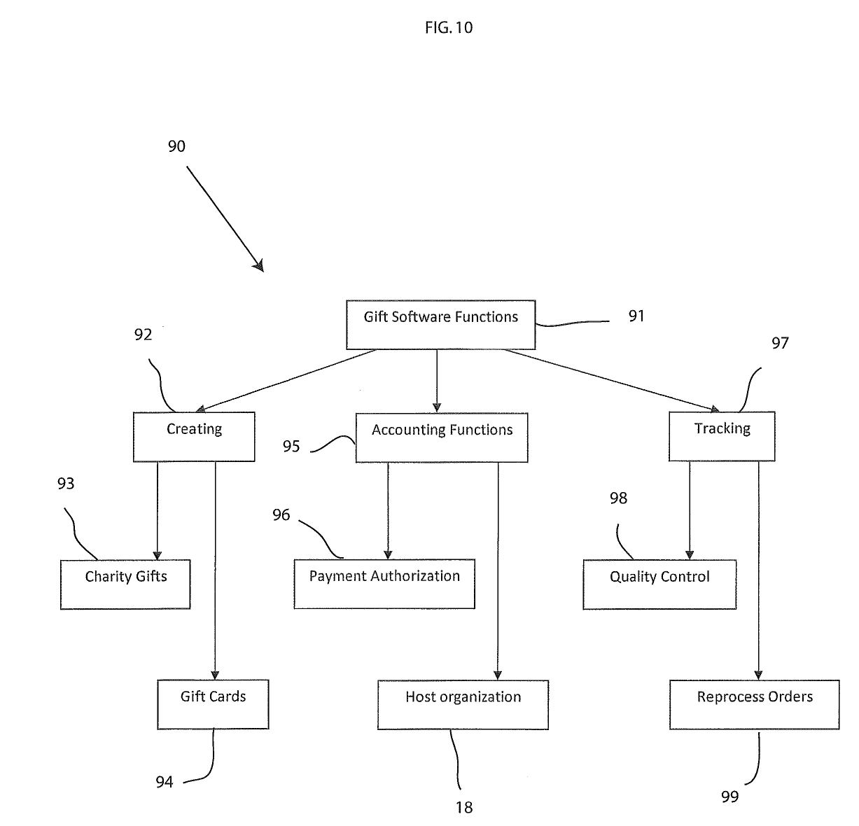

Shown in FIG. 10 is a flowchart 90 for gift software functions 91 according to one embodiment of the present invention. The gift software 91 is a tool for creating 92, tracking 97 and ensuring charity gifts 93 and gift cards 20 are tracked and delivered to their desired destination, such as the designated gift recipient 14. In addition it provides accounting functions 95 for the host organization 18. The application includes payment authorization 96, creation of a gift card 94 (print, e-mail, text messaging or other format), and tracking and quality control 98 of an order and ability to reprocess orders 99 if required. The gift software 91 can interface with a POS, the kiosk 100, website, mobile phone, personal display apparatus, television via the internet, smart card, etc. The gift software 91 also may be tied into a social networking site, instant messaging, voice over IP for giving between friends, family or buddies that frequent those sites.

For example in the case of a social networking site, a banner may be displayed that states “Give your friends and family the gift of giving”. The gift giver 12 would click on the banner display and access the gift software 91 for completing a transaction. The gift card 20 would be electronically transmitted to the gift recipient 14 through the social networking site. Alternatively, the gift recipient 14 would be sent an electronic message that they will be receiving a gift in the mail. The gift may be a physical card, such as the card 20, along with chocolates, a teddy bear, flowers or the like.

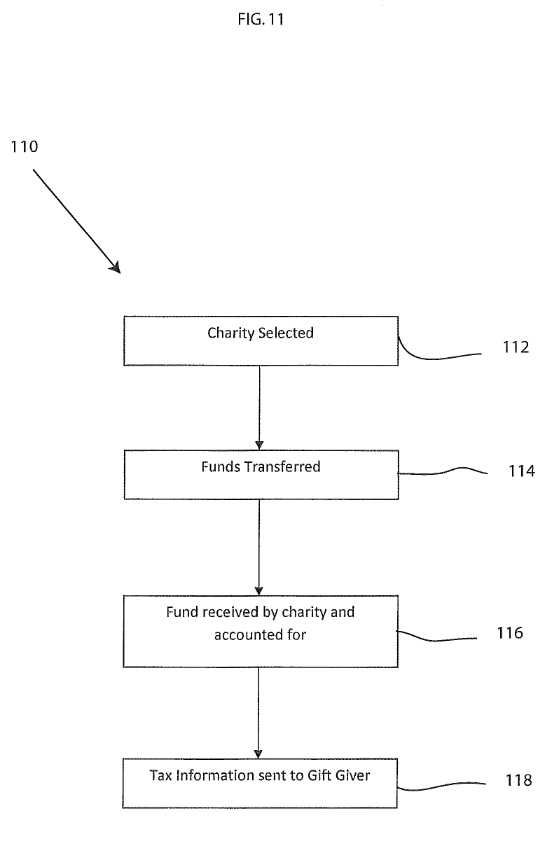

A Payment Process 110 is depicted in FIG. 11. The payment process 110 involves the distribution of funds to the donee charities 16 selected by the gift recipients 14. The charity 16 is selected 112, either by the gift recipient 14 or by default from the gift giver 12 in the case of a closed system card. The funds are then transferred 114 to the donee charity 16. The process concludes when the funds are received and accounted for 116 by the donee charity 16 and appropriate tax information sent to the gift giver 118.

A gift giver 12 accesses a server via a personal computer, cell phone, PDA other interface having a modem, wireless, broadband, Ethernet, digital subscriber line (DSL) or other communication means, such as through a network, wireless communication means, or the like. For example, the access may be through a POS system at a retail outlet which electronically transmits the desired information to the server 76 using a DSL. The gift giver 12 may purchase a pre-printed PVC or ABS gift card for example at a floral store which has a POS register or the kiosk 100 that transmits the data to the gift software and records the information on the server 76 for storage. The gift card 20 may be purchased in combination with flowers, chocolates, a teddy bear or other gift for the gift recipient 14 and transmitted to the gift recipient 14.

In another embodiment, the gift giver 12 purchases over their mobile phone an electronic gift card, and gift card which is electronically sent to a gift recipient. The gift card may be sent by an email, for example. The server 76 may alert representatives of the host 18, and those representatives may manually generate and send the gift card alone or along with other gifts such as flowers, chocolates, a teddy bear of the like. The gift may be sent for special occasions such as birthdays, bar mitzvahs, funerals, weddings, Mother's Day, Father's Day, graduation, baptism, birth of a child or the like. Upon receipt of the gift card, the gift recipient 14 may access the server 76 via a website 72, cell or mobile phone, PDA or the like to redeem the gift represented by gift card to designate a particular charity 16 or the pre-designated charity 32, typically by using a unique code, pin or password associated with the particular gift.

The gift giver 12 may create a gift card for conveying the gift to gift recipient 14 by accessing gift software on the website to customize the gift. The gift giver 12 can choose from a printed card 20, an e-card, a card they can print on his or her own printer, or no card at all. The card may have a special message on the card such as happy birthday, congratulations, with sympathy, etc on the card itself or may be enclosed in a special occasion card, such as a birthday card, with a plastic, PVC card with a magnetic strip, radio-frequency identification (RFID); bar coding, etc. The gift giver 12 may choose to private label the gift card with the brand or logo of a charity. In addition, the gift giver 12 may add a personal message to the card.

The gift giver 12 may select an amount for the donation. Typically in denominations such as $20.00, $100.00 or the like. A commission may be charged in addition to the set amount, or built into the set amount. The consumer may also be given the choice. In addition, the gift giver 12 specifies the gift recipient 14, e-mail, address and delivery information. The gift giver 12 may also provide other information to the host 18, such as specific charities or categories of charities that must or may not be selected as the donee charity 16. The gift giver 12 may choose whether or not the amount of the donation is displayed on the gift card or an additional attachment may be added to the same. To ensure all charitable donations go to charity, the gift giver 12 is asked to select a charity to benefit from the contribution should the gift recipient 14 not choose one so that no funds will be abandoned. A written agreement may accompany the gift card 20 to explain the process of what happens if the funds are not designated within a certain time period. All funds will be eventually donated to a donee charity 16.

In this way, the gift giver 12 purchases a prepaid charitable donation that is represented by a unique identifying code associated with that charitable gift. The host 18 provides this unique charitable gift identifier. The host 18 typically will sell gift cards upon which charitable gift identifiers are designated. The gift giver 12 may designate a group or predefined category of donee charities 16 from which the gift recipient 14 may choose, or designate specific charities or categories thereof which may not be selected by the gift recipient 14 (e.g., if the gift giver is opposed to abortion rights, he or she may select the Planned Parenthood organization as a charity that the gift recipient may not select). In addition, gifts may be made “in memoriam.”

Orders may be paid via credit card, cash or transfer payment. Alternative payment methods, such as purchase order or check, may also be accommodated. Card prices may be selectively adjusted based upon the number of cards ordered, or the size of the charitable donation.

The order is then submitted and is shipped to the gift recipient 14. After gift giver 12 submits the order, host ships 18 the gift card to gift recipient 14. The gift card is transmitted electronically or sent via mail. In a preferred embodiment, the card is accompanied by a tax receipt so that the gift recipient 14 may potentially obtain a tax benefit.

The gift recipient 14 then receives the card containing the identifier. The gift recipient 14 may redeem the gift as follows. The gift recipient 14 enters the charitable gift identifier at the web site on server (or via other communication means, such as telephonically, via email, modem, or the like), and searches among available options to find a charity for the gift. The options, which reside in charitable organizations database, may be centrally updated from time to time by the host. The gift recipient 14 chooses which charity will benefit from the donation (i.e., the donee charity), and confirms the selection. The charitable gift identifier acts as a redemption code so gift recipient may select the donee charity of his or her choice, potentially subject to constraints imposed by the gift giver 12.

Finally, the donee charity 16 is transmitted the charity donation. The host 18 then sends and the donee charity 16 receives the funds donated, preferably on a periodic basis, and multiple charity gifts are collected for disbursement. In a preferred embodiment, the host 18 allocates funds to all or most donee charities 16 chosen by various gift givers 12 and their gift recipients 14 on a monthly basis. The host 18 may further provide a report listing each funding allocation. The host 18 may provide the gift giver to keep confidential the names of gift recipients 14 and donors associated with each donation, unless provided express permission to release such information to the chosen charities.

Another embodiment of the present invention includes a method of charitable gift giving. The method comprises requesting a charitable gift card from a card request interface such as a web site or kiosk. The request may be made by a requesting means such as a kiosk, computer, mobile phone, personal display apparatus and television. The method further comprises receiving the charitable gift card from the card request interface. The charitable gift card may be tagged with identification information. The method further includes accessing a server and paying money to a host of the server, the host crediting a value of money to the charitable gift card corresponding to the paid money to the host. The method further includes giving the charitable gift card to a gift card recipient.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A system for facilitating charitable gift giving comprising:
a card interface configured to provide a charitable gift card to an individual, the charitable gift card tagged with identification information;
a server comprising:
a payment interface configured to accept a payment and credit a value of money corresponding to the payment to the charitable gift card, wherein
the payment interface is separate from the card interface; and
a charity selection interface configured to:
accept information related to the identification information;
receive a selection of a donee charity and an amount to be paid using the identification information;
pay the donee charity the amount to be paid; and
deduct the amount to be paid from the amount credited to the charitable gift card;
a card storage database in operable communication with the server, the card storage database containing data related to the identification information; and
an organization storage database in operable communication with the server, the storage database containing a list of selectable charitable organizations, the organization storage database accessible at least in part by a gift recipient.

2. The system of claim 1, wherein the card interface is the server.

3. The system of claim 1, wherein the card interface is a kiosk.

4. The system of claim 1, wherein the card interface is located at a location selected from the group consisting of health and fitness center, bank, corporation, post office, retail outlet, floral store, hospital, church, school, and shopping mall.

5. The system of claim 4, wherein the card interface is a display at the location.

6. The system of claim 1, wherein at least one of the card interface and the payment interface is further configured to allow a user to limit the number of donee charities available for selection.

7. The system of claim 1, wherein the server includes an interface configured to allow the requester to track the activity of the charitable gift card.

8. The system of claim 1, wherein a commission fee is deducted from the value of money credited to the charitable gift card.

9. A method of charitable gift giving comprising:
obtaining a charitable gift card from a card interface;
receiving the charitable gift card from the card interface, the charitable gift card tagged with identification information;
accessing a server and paying money to a host of the server, the host crediting a value of money to the charitable gift card corresponding to the paid money to the host, wherein the server and the card interface are at separate locations; and
giving the charitable gift card to a gift card recipient, wherein the server and the gift card are configured to allow a plurality of payments to be credited to the card.

10. The method of claim 9, wherein the card interface is a web site.

11. The method of claim 9, wherein the card interface is a kiosk.

12. The method of claim 9, wherein the obtaining is made by an obtaining means selected from the group consisting of a kiosk, computer, mobile phone, personal display apparatus, and television.

13. A method of facilitating charitable gift giving comprising:
establishing a plurality of card interfaces configured provide a charitable gift card to a gift giver;
tagging the charitable gift card with identification information;
establishing a web site comprising:
a payment interface; and
a charity selection interface;
accepting, by the payment interface, a payment by the gift giver;
crediting, by the payment interface, a value of money corresponding to the payment to the charitable gift card;
receiving, by the charity selection interface, a selection from a gift receiver of a donee charity and an amount to be paid;
paying the donee charity the amount to be paid; and
deducting the amount to be paid from the amount credited to the charitable gift card by the payment interface.

14. The method of claim 13, wherein the card interface is the server.

15. The method of claim 13, wherein the card interface is a kiosk.

16. The method of claim 13, wherein the card interface is located at a location selected from the group consisting of health and fitness center, bank, corporation, post office, retail outlet, floral store, hospital, church, school, and shopping mall.

17. The method of claim 13, wherein the payment interface and the card request interface are separate interfaces.

18. The method of claim 13, wherein at least one of the card interface and the payment interface is further configured to allow a user to limit the number of donee charities available for selection.

19. The method of claim 13, wherein the web site includes an interface configured to allow the requester to track the activity of the charitable gift card.

20. The method of claim 13, further comprising deducting a commission fee from the value of money credited to the charitable gift card.
